(19) United States
(12) Patent Application Publication
(10) Pub. No.: US 2010/0171731 A1
(43) Pub. Date: Jul. 8, 2010

(54) Source driver and drive method

(75) Inventor: Yoshiyuki Tanaka, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/654,203

(22) Filed: Dec. 14, 2009

(30) Foreign Application Priority Data
Jan. 8, 2009 (JP) 2009-002357

(51) Int. Cl. G09G 5/00

(52) U.S. Cl. 345/211

(57) ABSTRACT

A source driver according to an aspect of the present invention includes a vertical line counter that detects the number of pixels of a display panel in a vertical direction by a display signal used for display operation in the display panel, a bias circuit that adjusts bias current in accordance with the number of pixels that is detected by the vertical line counter, and a source amplifier that is supplied with the bias current that is adjusted by the bias circuit, the source amplifier outputting voltage to the display panel.

### BACKGROUND

1. Field of the Invention

The present invention relates to a source driver for driving a display panel, and a method of driving the display panel.

2. Description of Related Art

In a liquid crystal display panel driving IC for portable telephone, a source driver, a gate driver circuit (gate driver driving circuit when a gate driver circuit is formed in a liquid crystal panel), and a timing controller to control them are built therein in order to drive a TFT of the liquid crystal panel. The timing controller is a circuit that generates display timing from external display clock and a synchronization signal and performs control in accordance with the setting written in a register embedded in a driver by a serial interface.

In a portable telephone market where various manufacturers are competing, improvement of display quality and power saving are important issues for most of the manufacturers in order to differentiate their own products from those of competitors. Furthermore, to deal with various types of design in a flexible way, it is desirable that the number of control lines connected to a liquid crystal panel from a mother board of the telephone is as small as possible. For these reasons, some portable telephone manufacturers do not provide a serial interface for controlling display panel driving IC.

Further, a liquid crystal panel manufacturer may use a driving IC of the same product for panels having different sizes (pixel number). In this case, unless the bias current value of the source is adjusted, slew rate becomes insufficient to degrade display quality, or slew rate is so sufficient that it causes increase of power consumption. As such, the slew rate needs to be changed in accordance with the size of the display panel.

In order to secure generality in the display panel driving IC, it is important to secure appropriate display quality and appropriate power consumption without being controlled by the telephone side such as the serial interface or the like regardless of the usage, for example, even when the size of the panel that is driven is changed.

FIG. 12 is a circuit diagram of a source driver 51 according to a related art 1. The source driver 51 according to the related art 1 includes a bias circuit 52, a controller 53, and a source amplifier 54. The bias circuit 52 includes a current mirror circuit to flow in MP52 the same current I51 as current IREF51 that flows in MP51, a current mirror circuit to flow in MP53 current I52 which is twice as large as IREF51, MP54 which is a switch to turn on/off I52, a current mirror circuit to flow in MP55 the same current I53 as IREF51, MP56 which is a switch to turn on/off I53, and a current mirror circuit to flow in MN52 the same current I55 as current I54 (I54=I51+I52+I53) that flows in MN51. The bias circuit 52 flows the current I55 in MN52 to supply operation bias current to the source amplifier 54.

The controller 53 includes a serial interface circuit 55 to take control signals from a telephone side, and a register 56 of n bits (two bits in FIG. 12) to store information that is taken. The controller 53 controls ON/OFF of MP54 and MP56 by a set signal in the register 56. The source amplifier 54 outputs gray scale voltage according to the input data.

The operation of the source driver 51 according to the related art 1 shown in FIG. 12 is as follows.
1) ADJ<1:0> is written into the register 56 by the serial interface circuit 55.
2) When the register ADJ<1:0> is 00, MP54 is OFF, MP56 is OFF, I55=I54=I51=IREF51 is satisfied, and the operation bias current which is equal to IREF51 is supplied to the source amplifier 54.

When the register ADJ<1:0> is 01, MP54 is OFF, MP56 is ON, I55=I54=I51+I53=IREF51+IREF51 is satisfied, and the operation bias current which is twice as large as when the register ADJ<1:0> is 00 is supplied to the source amplifier 54.

When the register ADJ<1:0> is 10, MP54 is ON, MP56 is OFF, I55=I54=I51+I52=IREF51+2×IREF51 is satisfied, and the operation bias current which is three times as large as when the register ADJ<1:0> is 00 is supplied to the source amplifier 54.

When the register ADJ<1:0> is 11, MP54 is ON, MP56 is ON, I55=I54=I51+I52+153=IREF51+2×IREF51+IREF51 is satisfied, and the operation bias current which is four times as large as when the register ADJ<1:0> is 00 is supplied to the source amplifier 54.
3) The slew rate and the consumed current of the source amplifier 54 are determined by the operation bias current.

FIG. 13 shows a relation between the slew rate and the bias current (bias setting value) in the source amplifier 54. When the operation bias current I55 decreases by ADJ<1:0>, slew rate is made lower, and vice versa. FIG. 14 shows a relation between the bias current (bias setting value) and the consumed current in the source amplifier 54. The decrease of the operation bias current I55 reduces the consumed current, and vice versa.

For example, assume a case in which display panels whose number of lines are different are driven with the same IC. In this case, when the frame frequency is the same, time allowed to charge gray scale voltage for one pixel capacity becomes shorter in the panel having larger number of display lines. Thus, the source amplifier output voltage needs to reach desired value in high speed. In short, the slew rate is required to be high.

On the other hand, when the number of display lines is small, time allowed to charge gray scale voltage for one pixel capacity becomes longer. Thus, time required for the source amplifier output voltage reaches a desired value may be long. In summary, the slew rate may be low. As for power consumption, it is desirable to make it lower as long as the quality of the image can be maintained, and thus the slew rate is desirably made slow, if possible.

The source driver 51 according to the related art 1 sets appropriate bias setting as the size of the display panel mounted on a telephone by a serial interface from the telephone side. Accordingly, even when the size of the display panel driven by IC is changed, the slew rate and the consumed current can be set as appropriate.

The device disclosed in Japanese Unexamined Patent Application Publication No. 2003-66919 (Tatsuke) is a display panel drive device, which generates signals to switch high bias and low bias of operation bias current of an amplifier by counting the number of clocks from rising to falling of a control input signal having pulse width in accordance with display line.

For example, similarly to the device disclosed by Tatsuke, it is possible to provide a technique of switching bias current in accordance with the panel size by counting the number of clocks from falling to rising of the pulse of the control input signal (HSYNC or VSYNC) having pulse width in accordance with the size of the display panel. This is shown by source driver 61 according to a related art 2, the circuit of which being shown in FIG. 15.

In addition to a bias circuit 62 and a source amplifier 64 whose configuration is similar to those of the source driver 51 stated above, the source driver 61 according to the related art 2 further includes a controller 63 that includes a HSYNC Low period counter 65 that counts the Low period of the horizontal synchronizing signal (HSYNC) from the telephone side using a display clock signal (DOTCLK) and a decoder 66 that generates n-bit (two bits in the circuit diagram) signal to control ON/OFF of MP64 and MP66 from the count value.

The operation of the source driver 61 according to the related art 2 is as follows.
1) The horizontal synchronizing signal (HSYNC) and the display clock (DOTCLK) are input to the controller 63 as display signals. A predetermined value is input as the Low width of HSYNC in accordance with the number of display lines. For example, the signals are input with a Low width of 4 DOTCLK in 320 lines, and with a Low width of 3 DOTCLK in 400 lines.
2) The HSYNC Low period counter 65 detects what DOTCLK the Low width of the HSYNC that is input corresponds to. For example, the counter 65 counts 5DOTCLK when the number of lines of the panel is 176 lines (FIG. 16A), 4DOTCLK when the number of lines is 320 lines (FIG. 16B), and 3DOTCLK when the number of lines is 400 lines (FIG. 16C).
3) The count value is input to the decoder 66, and the control signal ADJ<1:0> of n bits (two bits in the circuit diagram) is generated as shown in a table of FIG. 17.
4) When the control signal ADJ<1:0> is 00, MP64 is OFF, MP66 is OFF, I65=I64=I61=IREF61 is satisfied, and the operation bias current which is equal to IREF61 is supplied to the source amplifier 64.

When ADJ<1:0> is 01, MP64 is OFF, MP66 is ON, I65=I64=I61+I63=IREF61+IREF61 is satisfied, and the operation bias current which is twice as large as when ADJ<1:0> is 00 is supplied to the source amplifier 64.

When ADJ<1:0> is 10, MP64 is ON, MP66 is OFF, I65=I64=I61+I62=IREF61+2×IREF61 is satisfied, and the operation bias current which is three times as large as when ADJ<1:0> is 00 is supplied to the source amplifier 64.

When ADJ<1:0> is 11, MP64 is ON, MP66 is ON, I65=I64=I61+I62+163=IREF61+2×IREF61+IREF61 is satisfied, and the operation bias current which is four times as large as when ADJ<1:0> is 00 is supplied to the source amplifier 64.
5) When the display panel of 240×400 lines is used in the telephone side in the driving IC where the initial setting of ADJ<1:0> is 240×320, if HSYNC having Low width that corresponds to 3DOTCLK is input from the telephone side, ADJ<1:0> is changed from 01 to 10, the slew rate is made higher than a case of 320 lines. Accordingly, the slew rate and the consumed current can be set appropriately even when the size of the display panel is changed.

### SUMMARY

However, the present inventors have found a problem that, in the source driver 51 of the related art 1 shown in FIG. 12, the burden for the user increases as the register value needs to be set by the serial interface from the telephone side in accordance with the size of the display panel that is used (pixel number).

Some applications do not include the serial interface. In this case, the slew rate needs to be set in accordance with the size of the display panel which is the largest under the conditions of use. When it is used with the display panel having small size without changing the setting of the slew rate, consumed current increases. Further, when the slew rate is set in accordance with the size of the standard display panel in order to reduce power consumption, the slew rate is insufficient and the image quality is degraded when used with the display panel having larger size without changing the setting of the slew rate.

Also in the source driver 61 according to the related art 2 shown in FIG. 15, HSYNC having different Low widths needs to be supplied from the telephone side in accordance with the size of the display panel, which increases the burden for the user.

A first exemplary aspect of an embodiment of the present invention is a source driver including a detector that detects the number of pixels of a display panel by a display signal used for display operation in the display panel, an adjustment circuit that adjusts bias current in accordance with the number of pixels that is detected in the detector, and an amplifier that is supplied with the bias current that is adjusted by the adjustment circuit, the amplifier outputting voltage to the display panel.

According to such a configuration, it is possible to control the operation bias current of the source amplifier with no special external control signal in accordance with the number of pixels of the display panel. Accordingly, when the number of pixels is large and thus high slew rate is required, the bias current can be increased to make slew rate higher. On the other hand, when the number of pixels is small and thus low slew rate is desired, the bias current can be decreased to make slew rate lower, whereby reducing the power consumption.

A second exemplary aspect of an embodiment of the present invention is a drive method including detecting the number of pixels of a display panel by a display signal used for display operation in the display panel, adjusting bias current in accordance with the number of pixels that is detected, and supplying the bias current that is adjusted to an amplifier, and outputting voltage to the display panel.

According to the present invention, it is possible to control the operation bias current of the source amplifier without any special external control signal in accordance with the pixel number of the display panel. Accordingly, the slew rate and the consumed current can be adjusted as appropriate.

According to the present invention, it is possible to provide a source driver and a drive method that make it possible to adjust the operation bias current in accordance with the change of the size of the display panel with no external control.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a diagram showing the configuration of a source driver according to a first exemplary embodiment;

FIG. 2 is a diagram showing control signals generated by a decoder used in the source driver according to the first exemplary embodiment;

FIGS. 3A to 3C are diagrams showing examples of display panels driven by the source driver according to the first exemplary embodiment;

FIG. 4 is a diagram showing a control signal ADJ<0:1> depending on the vertical line number in accordance with the display panels shown in FIGS. 3A to 3C;

FIG. 5 is a diagram showing the configuration of a source driver according to a second exemplary embodiment;

FIGS. 6A to 6C are diagrams for describing count operation of horizontal effective pixels used in the source driver according to the second exemplary embodiment;

FIG. 7 is a diagram showing control signals generated by a decoder used in the source driver according to the second exemplary embodiment;

FIGS. 8A to 8C are diagrams showing examples of display panels driven by the source driver according to the second exemplary embodiment;

FIGS. 9A to 9C are diagrams showing a control signal ADJ<0:1> in accordance with the vertical line number corresponding to the display panels shown in FIGS. 8A to 8C, respectively;

FIG. 10 is a diagram showing the configuration of a source driver according to a third exemplary embodiment;

FIG. 11 is a timing chart showing one example of a panel select signal and a source select signal of the source driver according to the third exemplary embodiment;

FIG. 12 is a diagram showing the configuration of a source driver according to a related

FIG. 13 is a diagram showing a relation between bias current and slew rate according to the related art 1;

FIG. 14 is a diagram showing a relation between bias current and consumed current according to the related art 1;

FIG. 15 is a diagram showing the configuration of a source driver according to a related art 2;

FIGS. 16A to 16C are diagrams for describing the operation of the source driver according to the related art 2; and

FIG. 17 is a diagram showing control signals of the related art 2.

### DETAILED DESCRIPTION OF THE EXEMPLARY EMBODIMENTS

### First Exemplary Embodiment

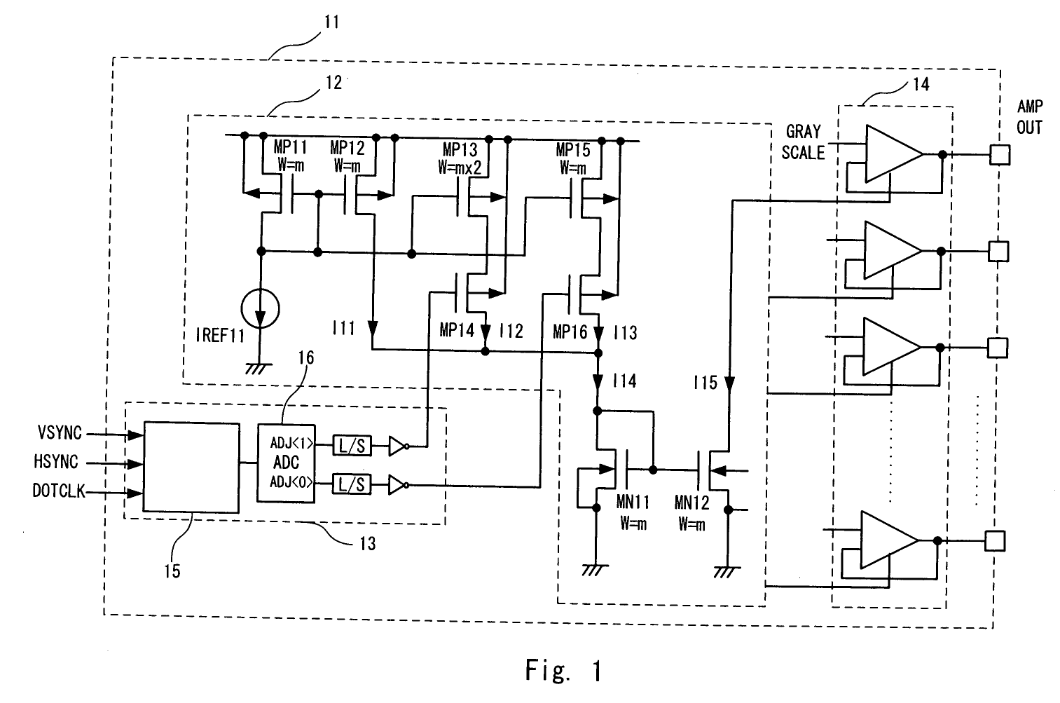

A source driver according to the first exemplary embodiment of the present invention will be described with reference to FIG. 1. FIG. 1 is a diagram showing the configuration of a source driver 11 according to the first exemplary embodiment. As shown in FIG. 1, the source driver 11 includes a bias circuit 12, a controller 13, and a source amplifier 14.

The bias circuit 12 includes a current mirror circuit to flow in MP12 current I11 that is the same to current IREF11 that flows in MP11, a current mirror circuit to flow current I12 that is twice as large as IREF11 in MP13, MP14 which is a switch to turn on/off I12, a current mirror circuit to flow current I13 that is the same to current IREF11 in MP15, MP16 which is a switch to turn on/off I13, and a current mirror circuit to flow in MN12 current I15 that is the same as current I14(I14=I11+I12+I13) flowing in MN11. The bias circuit 12 flows current I15 in MN12 to supply operation bias current to the source amplifier 14. Note that all the gate lengths L of the transistor are the same. Gate widths W of MP11, MP12, MP15, MN11, and MN12 are all m, and a gate width of MP13 is m×2.

The controller 13 includes a vertical line counter 15 and a decoder ADC 16. The vertical line counter 15 receives a vertical synchronizing signal VSYNC, a horizontal synchronizing signal HSYNC, and a dot clock DOTCLK from a portable telephone side, to determine the number of lines in a display panel in one frame period. In summary, the vertical line counter 15 detects the vertical pixel number of the display panel in the first exemplary embodiment. The vertical synchronizing signal VSYNC, the horizontal synchronizing signal HSYNC, and the dot clock DOTCLK are display signals that are definitely used for display operation.

The number of lines of the horizontal synchronizing signal HSYNC between the adjacent vertical synchronizing signals VSYNC is substantially equal to the number of lines of a panel. More specifically, the number of lines of the horizontal synchronizing signal HSYNC is obtained by adding the number of lines of blanking to the number of display lines. Accordingly, the vertical line counter 15 is able to determine the substantial value of the number of lines in the display panel by counting the number of lines of the horizontal synchronizing signal HSYNC between the adjacent vertical synchronizing signals VSYNC.

The decoder ADC 16 generates a control signal ADJ<1:0> of n bits in accordance with the count value in the vertical line counter 15. Note that, in the first exemplary embodiment shown in FIG. 1, the decoder ADC 16 generates the control signal of two bits as an example. The decoder ADC 16 generates the control signal ADJ<1:0> so that the slew rate corresponds to the size of the display panel. The source amplifier 14 outputs gray scale voltage in accordance with the input data.

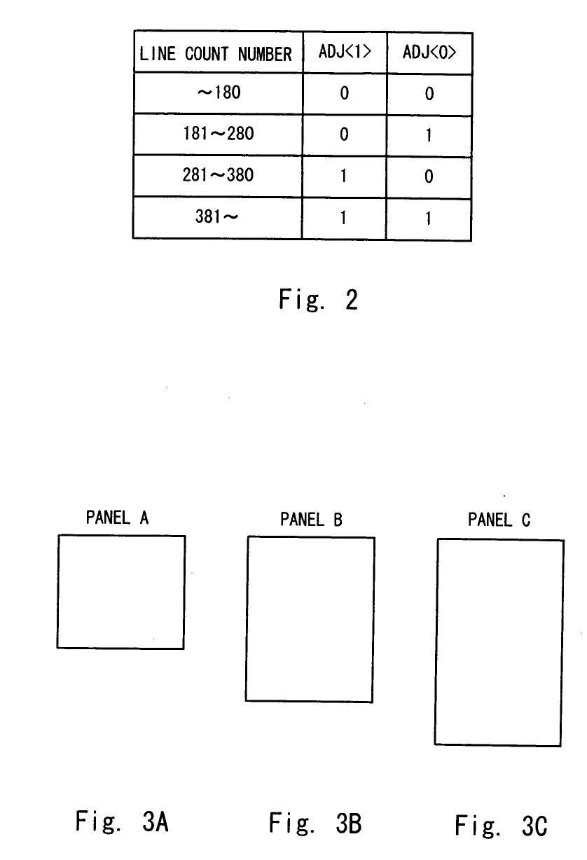

The operation of the source driver 11 in the first exemplary embodiment is as follows.
1) The vertical synchronizing signal (VSYNC), the horizontal synchronizing signal (HSYNC), and the clock (DOTCLK) are input to the controller 13 as display signals.
2) The vertical line counter 15 counts the number of horizontal synchronizing signals HSYNC in a period from the vertical synchronizing signal VSYNC that is input to the next vertical synchronizing signal VSYNC.
3) The count value in the vertical line counter 15 is input to the decoder ADC 16, and the control signal ADJ<1:0> in accordance with the count value is generated. FIG. 2 shows one example of the control signal ADJ<1:0> generated in the decoder ADC 16. As shown in FIG. 2, for example, the decoder ADC 16 generates ADJ<1:0>=00 when the count value in the vertical line counter 15 is 180 or less. Further, when the count value in the vertical line counter 15 is from 181 to 280, the decoder ADC 16 generates ADJ<1:0>=01. When the count value is from 281 to 380, the decoder ADC 16 generates ADJ<1:0>=10. When the count value in the vertical line counter 15 is 381 or more, the decoder ADC 16 generates ADJ<1:0>=11.
4) When the control signal ADJ<1:0> is 00, MP14 is OFF, and MP16 is OFF. Thus, I15=I14=I11=IREF11 is satisfied, and the operation bias current that is equal to IREF11 is supplied to the source amplifier 14.

When ADJ<1:0> is 01, MP14 is OFF, and MP16 is ON. Thus, I15=I14=I11+I13=IREF11+IREF11 is satisfied, and the operation bias current which is twice as large as the case of ADJ<1:0>=00 is supplied to the source amplifier 14.

When ADJ<1:0> is 10, MP14 is ON, and MP16 is OFF. Thus, I15=I14=I11+I12=IREF11+2×IREF11 is satisfied, and the operation bias current which is three times as large as the case of ADJ<1:0>=00 is supplied to the source amplifier 14.

When ADJ<1:0> is 11, MP14 is ON, and MP16 is ON. Thus, I15=I14=I11+I12+I13=IREF11+2×IREF11+IREF11 is satisfied, and the operation bias current which is four times as large as the case of ADJ<1:0>=00 is supplied to the source amplifier 14.
5) When the size of the panel is changed, for example from 320 lines to 400 lines, ADJ<1:0> is changed from 10 to 11. Thus, the slew rate is made higher than the case of 320 lines. Further, when the size of the panel is changed from 320 lines to 240 lines, the output ADJ<1:0> of the decoder ADC16 is changed from 10 to 01, which means the slew rate is made lower than the case of 320 lines.

In the present invention, focusing on a fact that the number of lines of the horizontal synchronizing signal HSYNC between the adjacent vertical synchronizing signals VSYNC definitely used for display operation is substantially equal to the number of lines of the panel, a counter to detect the number of HSYNC for every vertical synchronizing signal VSYNC is provided in the driver. Accordingly, it is possible to detect the number of lines of the panel as the count value and to generate the bias control signal of n bits in accordance with the result.

FIGS. 3A to 3C show three examples of the display panel (panel A, panel B, panel C). In the panel A shown in FIG. 3A, the vertical line number is 176. In the panel B shown in FIG. 3B, the vertical line number is 320. In the panel C shown in FIG. 3C, the vertical line number is 400.

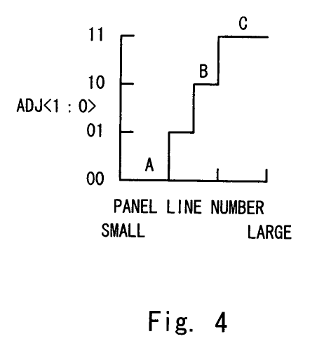

As the vertical line number is 176 in the panel A, the control signal ADJ<0:1> generated in the decoder ADC16 is 01. As the vertical line number is 320 in the panel B, the control signal ADJ<0:1> generated in the decoder ADC16 is 10. As the vertical line number is 400 in the panel C, the control signal ADJ<0:1> generated in the decoder ADC16 is 11. In summary, as shown in FIG. 4, the appropriate control signal ADJ<0:1> is generated in accordance with the vertical line number of the panel. Thus, the operation bias current of the source amplifier 14 can be controlled by this control signal as stated above.

As stated above, according to the present invention, when the vertical size of the panel that is to be driven is changed, it is possible to automatically detect the number of lines by the driver itself and to adjust the slew rate and the consumed current as appropriate in accordance with the result. Thus, it is possible for the driver itself to automatically detect the change of the number of lines of the display panel with no special external control signal to control the operation bias current of the source amplifier 14.

As a result, the slew rate and the consumed current can be adjusted to the appropriate state even when the number of lines of the panel that is to be driven is changed. In summary, when the number of lines of the panel is increased and thus high slew rate is required, the bias current is increased to realize higher slew rate. On the other hand, when the number of lines of the panel is decreased and thus low slew rate is desired, the bias current is decreased to realize lower slew rate in order to reduce the power consumption.

### Second Exemplary Embodiment

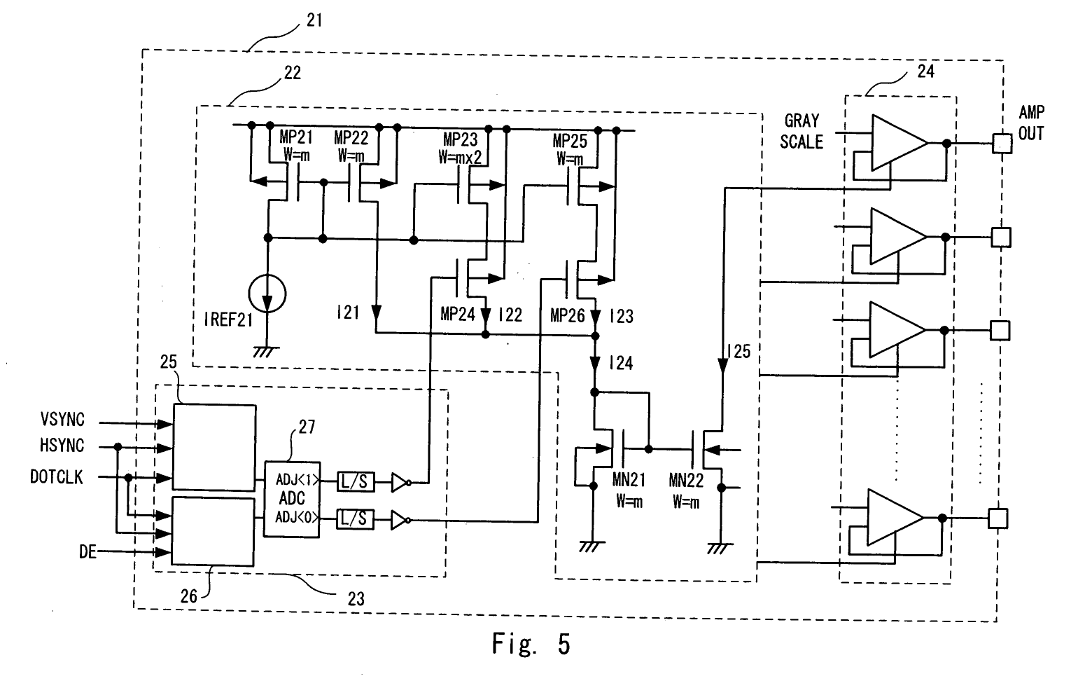

A source driver according to the second exemplary embodiment of the present invention will be described with reference to FIG. 5. FIG. 5 is a diagram showing the configuration of a source driver 21 according to the second exemplary embodiment. As shown in FIG. 5, the source driver 21 includes a bias circuit 22, a controller 23, and a source amplifier 24. The bias circuit 22 supplies bias current to the source amplifier 24. The source amplifier 24 outputs gray scale voltage in accordance with the input data. The bias circuit 22 and the source amplifier 24 are similar to those employed in the first exemplary embodiment, and therefore the description thereof will be omitted. Note that all the gate lengths L of the transistor are the same. The gate widths W of MP11, MP12, MP15, MN11, and MN12 are all m, and the gate width of MP13 is m×2.

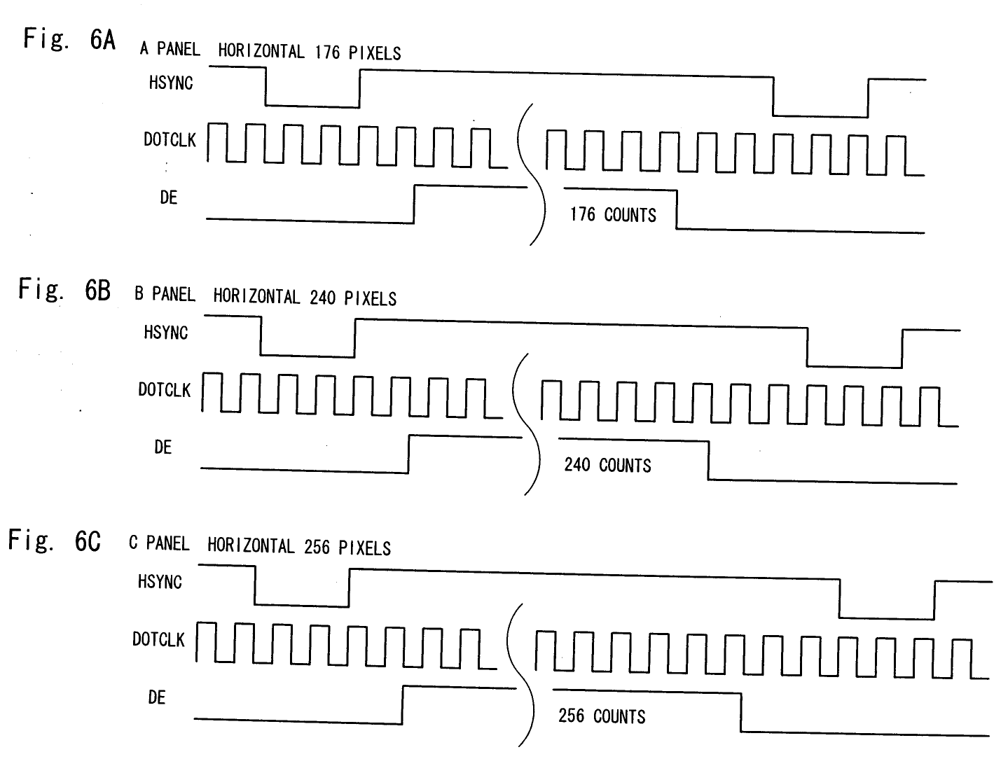

The controller 23 includes a vertical line counter 25, a display pixel counter 26, and a decoder ADC 27. The controller 23 according to the second exemplary embodiment is different from the controller 13 of the first exemplary embodiment in that the display pixel counter 26 is provided. The display pixel counter 26 takes a data enable signal DE and the horizontal synchronizing signal HSYNC from a portable telephone side by dot clock DOTCLK, so as to judge effective pixels in one line period. The decoder ADC 27 generates the bit signal according to the count values of the vertical line counter 25 and the display pixel counter 26. Note that, in the second exemplary embodiment, the decoder ADC 27 generates the control signal of two bits. The operation of the source driver 21 according to the second exemplary embodiment is as follows.
1) The vertical synchronizing signal VSYNC, the horizontal synchronizing signal HSYNC, the data enable signal DE, and the clock (DOTCLK) are input to the controller 23 as display signals.
2) The vertical line counter 25 counts the number of horizontal synchronizing signals HSYNC in a period from the vertical synchronizing signal VSYNC that is input to the next vertical synchronizing signal VSYNC. As described above, the number of lines of the horizontal synchronizing signal HSYNC between the adjacent vertical synchronizing signals VSYNC definitely used for display operation is substantially the same as the number of lines of the panel. Accordingly, the vertical line counter 25 judges the substantial value of the number of lines of the panel by counting the number of lines of the horizontal synchronizing signal HSYNC.
3) The display pixel counter 26 counts the number of clocks of the data enable signal DE in an active period in a period from the horizontal synchronizing signal HSYNC that is input to the next horizontal synchronizing signal HSYNC. FIGS. 6A to 6C show examples of the horizontal synchronizing signal HSYNC, the data enable signal DE, and the dot clock. FIG. 6A shows a case where the horizontal pixel number is 176 pixels, FIG. 6B shows a case where the horizontal pixel number is 240 pixels, and FIG. 6C shows a case where the horizontal pixel number is 256 pixels.

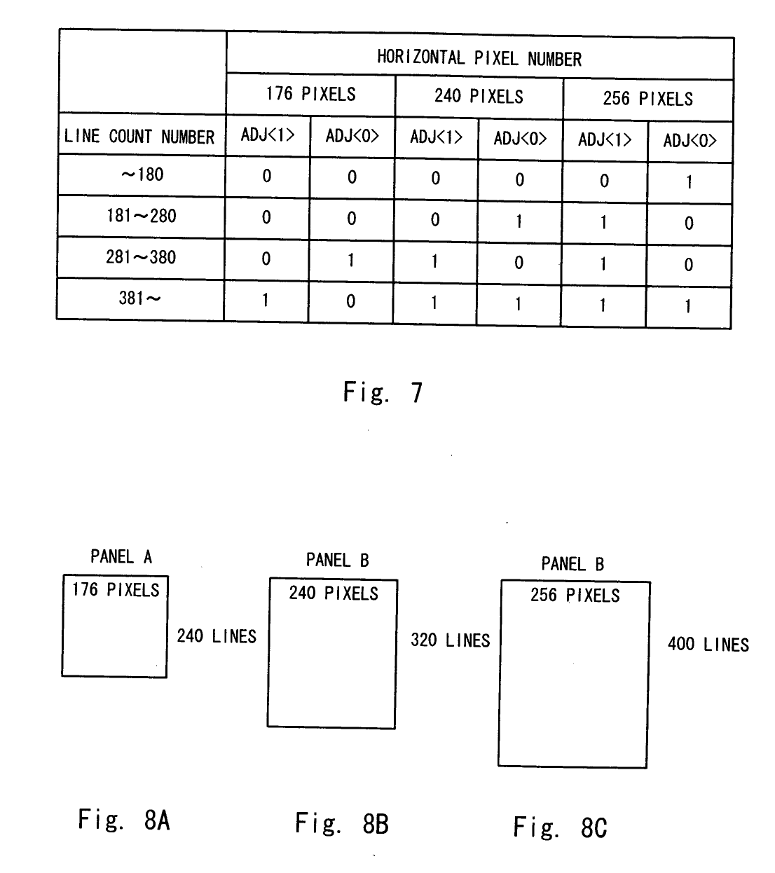

In the example shown in FIG. 6A, the number of dot clocks DOTCLK in a period where the data enable signal is in active is 176 counts, which is equal to the horizontal pixel number, between the adjacent horizontal synchronizing signals HSYNC. Similarly, the number is 240 counts in the example shown in FIG. 6B, and the number is 256 counts in the example shown in FIG. 6C.
4) Then, the count values counted in the vertical line counter 25 and the display pixel counter 26 are input to the decoder ADC 27, so as to generate the control signal ADJ<1:0> in accordance with the count value. FIG. 7 shows one example of the control signal ADJ<1:0> generated in the decoder ADC 27. As shown in FIG. 7, for example, when the horizontal pixel number is 176 pixels, the decoder ADC 27 generates the control signal ADJ<1:0>=00 when the vertical line count number is 180 or less or from 181 to 280, generates ADJ<1:0>=01 when the number is from 281 to 380, and generates ADJ<1:0>=10 when the number is 381 or more.

Further, when the horizontal pixel number is 240 pixels, the decoder ADC 27 generates the control signal ADJ<1:0>=00 when the vertical line count number is 180 or less, generates ADJ<1:0>=01 when the number is from 181 to 280, generates ADJ<1:0>=10 when the number is from 281 to 380, and generates ADJ<1:0>=11 when the number is 381 or more. Furthermore, when the horizontal pixel number is 256 pixels, the decoder ADC 27 generates the control signal ADJ<1:0>=01 when the vertical line count number is 180 or less, generates ADJ<1:0>=10 when the number is from 181 to 280, generates ADJ<1:0>=10 when the number is from 281 to 380, and generates ADJ<1:0>=11 when the number is 381 or more.
5) When the control signal ADJ<1:0> is 00, MP24 is OFF, and MP26 is OFF. Thus, I25=I24=I21=IREF21 is satisfied, and the operation bias current that is equal to IREF21 is supplied to the source amplifier 24.

When ADJ<1:0> is 01, MP24 is OFF, MP26 is ON, I25=I24=I21+I23=IREF21+IREF21 is satisfied, and the operation bias current which is twice as large as a case where ADJ<1:0> is 00 is supplied to the source amplifier 24. When ADJ<1:0> is 10, MP24 is ON, and MP26 is OFF. Thus, I25=I24=I21+I22=IREF21+2×IREF21 is satisfied, and the operation bias current that is three times as large as where ADJ<1:0> is 00 is supplied to the source amplifier 24.

When ADJ<1:0> is 11, MP24 is ON, and MP26 is ON. Thus, I25=I24=I21+I22+I23=IREF21+2×IREF21+IREF21 is satisfied, and the operation bias current that is four times as large as a case where ADJ<1:0> is 00 is supplied to the source amplifier 24.
6) When the size of the display panel is changed, for example, from 240×320 to 240×400, ADJ<1:0> is changed from 10 to 11. Thus, the slew rate is made higher. Further, when the size is changed from 240×320 to 176×240, the output ADJ<1:0> of the ADC circuit is changed from 10 to 00, which means the slew rate is made lower.

As described above, according to the present invention, when the size of the panel that is to be driven is changed, it is possible for the driver itself to automatically detect the number of lines and the horizontal effective pixels and to adjust the slew rate and the consumed current as appropriate according to the result.

In the second exemplary embodiment, focusing on a fact that width in which the data enable signal DE used for transmitting the display data becomes active in one horizontal period is equal to the effective pixels, the display pixel counter 26 that detects the number of clocks in a period in which the data enable signal DE between the adjacent horizontal synchronizing signals HSYNC becomes active is provided in the driver in addition to the vertical line counter 25 employed in the first exemplary embodiment. Accordingly, the horizontal effective pixels and the number of lines of the display panel can be automatically detected (detected as count values). Accordingly, the slew rate and the consumed current can be adjusted in accordance with the change of size of the display panel in the horizontal direction in addition to the vertical direction.

FIGS. 8A to 8C show three examples of the display panel (panel A, panel B, and panel C). In the panel A shown in FIG. 8A, the vertical line number is 240 and the horizontal pixel number is 176. In the panel B shown in FIG. 8B, the vertical line number is 320 and the horizontal pixel number is 240. In the panel C shown in FIG. 8C, the vertical line number is 400 and the horizontal pixel number is 256.

As the horizontal pixel number is 176 and the vertical pixel number is 240 in the panel A, the control signal ADJ<0:1> generated in the decoder ADC 27 is 00 as shown in FIG. 7. As the vertical line number is 320 and the horizontal pixel number is 240 in the panel B, the control signal ADJ<0:1> generated in the decoder ADC 27 is 10. As the vertical line number is 400 and the horizontal pixel number is 256 in the panel C, the control signal ADJ<0:1> generated in the decoder ADC 27 is 11.

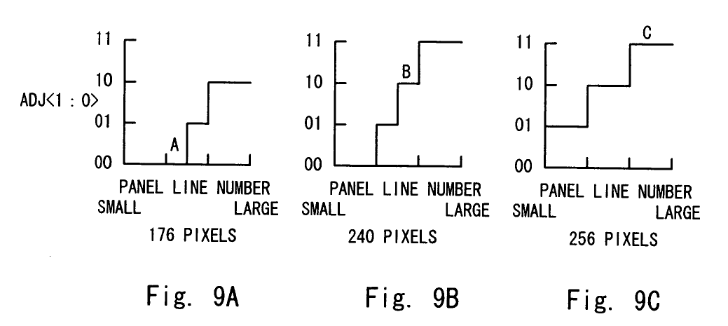

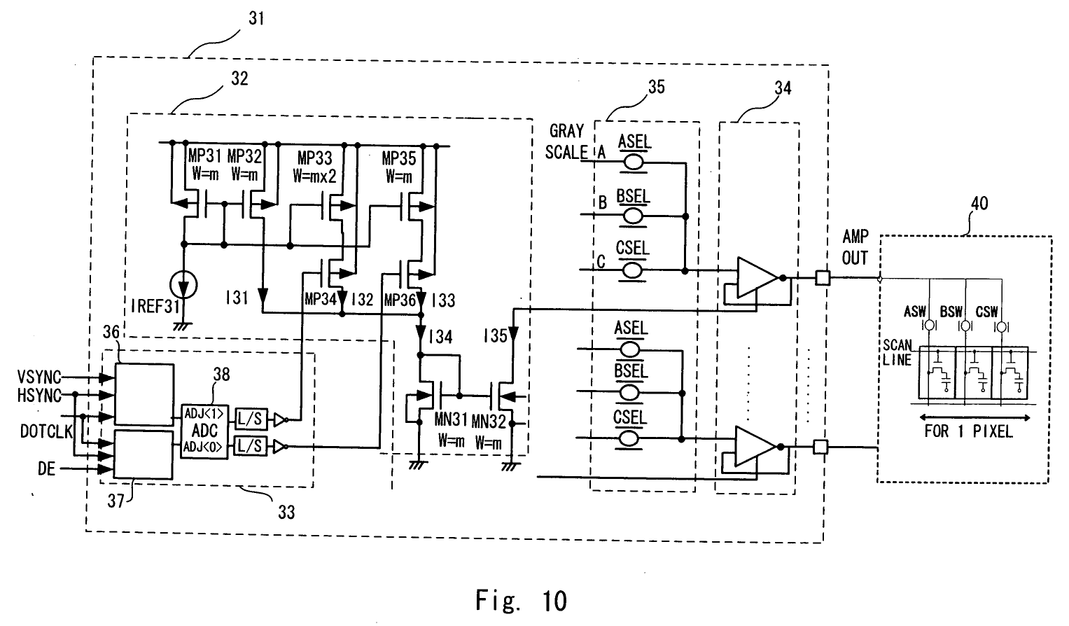

FIGS. 9A to 9C show the control signal ADJ<0:1> in accordance with the vertical line number that corresponds to FIGS. 8A to 8C, respectively. As shown in FIGS. 9A to 9C, the appropriate control signal ADJ<0:1> is generated in accordance with the horizontal pixel number and the vertical line number of each display panel. The operation bias current of the source amplifier 24 can be controlled by this control signal as stated above.

As stated above, according to the second exemplary embodiment, it is possible to automatically detect the change of the size of the display panel by the driver itself with no special control signal from a user, so as to control the operation bias current of the source amplifier. As a result, the slew rate and the consumed current can be adjusted to the appropriate state even when the size of the display panel that is to be driven is changed. In other words, when the panel size is increased and thus high slew rate is required, the bias current is increased to realize higher slew rate. On the other hand, when the panel size is decreased and thus low slew rate is desired, the bias current is decreased to realize lower slew rate in order to reduce the power consumption.

### Third Exemplary Embodiment

The configuration of a source driver according to the third exemplary embodiment of the present invention will be described with reference to FIG. 10. FIG. 10 is a diagram showing the configuration of a source driver 31 according to the third exemplary embodiment. Although description has been made with a source driver where one pixel data is outputted from one output in the first and second exemplary embodiments, the similar control can be performed also in the source driver of output division multiplex driving method mainly used in the liquid crystal panel of low-temperature poly-silicon (LTPS). The source driver 31 according to the third exemplary embodiment employs an output division multiplex driving method.

As shown in FIG. 10, the source driver 31 includes a bias circuit 32, a controller 33, a source amplifier 34, a source selector 35, a vertical line counter 36, a horizontal display pixel counter 37, and a decoder ADJ 38. The source selector 35 selects the gray scale voltage in accordance with the input data for every output. The number of amplifiers of the source amplifier 34 is less than that of the source amplifier 24 of the second exemplary embodiment by the number equal to the number of time division. As the configuration of the bias circuit 32, the controller 33, and the source amplifier 34 is the same as that employed in the second exemplary embodiment, the description thereof will be omitted.

In case of the output division multiplex driving method, the gray scale voltage is output from the driver by being switched in one horizontal period. Thus, one pixel or more of the liquid crystal panel can be controlled with one output. The display data input to the source driver 31 is controlled in the controller 33, and is output to the source amplifier 34 as the gray scale data. Further, the controller 33 generates panel select signals (switch turning control signals) ASW, BSW, CSW, and source select signals (source output switch signals) ASEL, BSEL, CSEL.

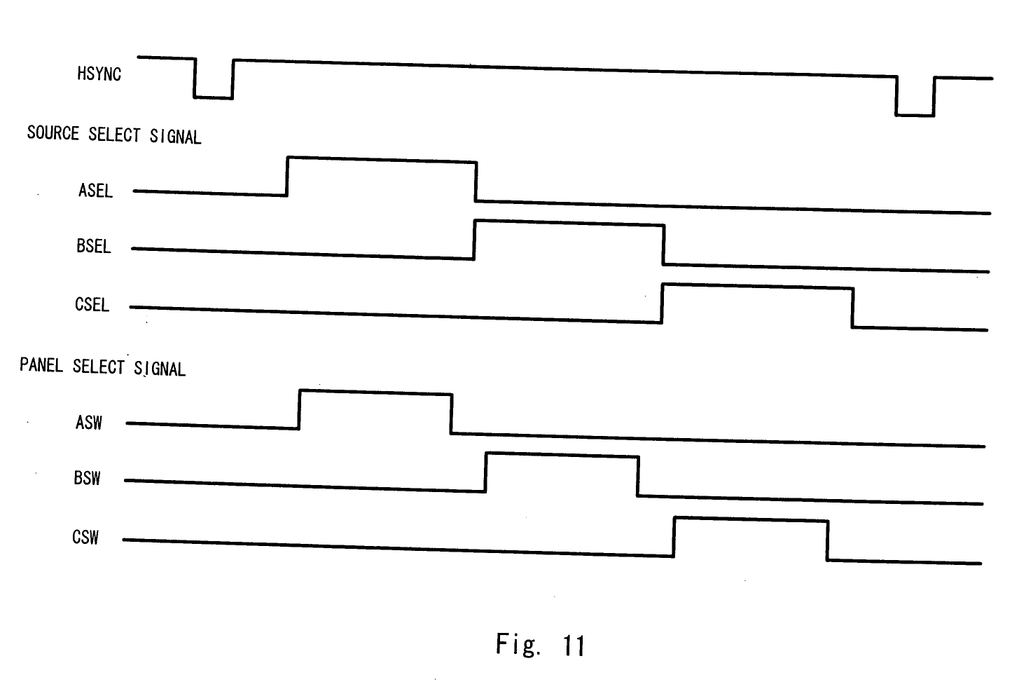

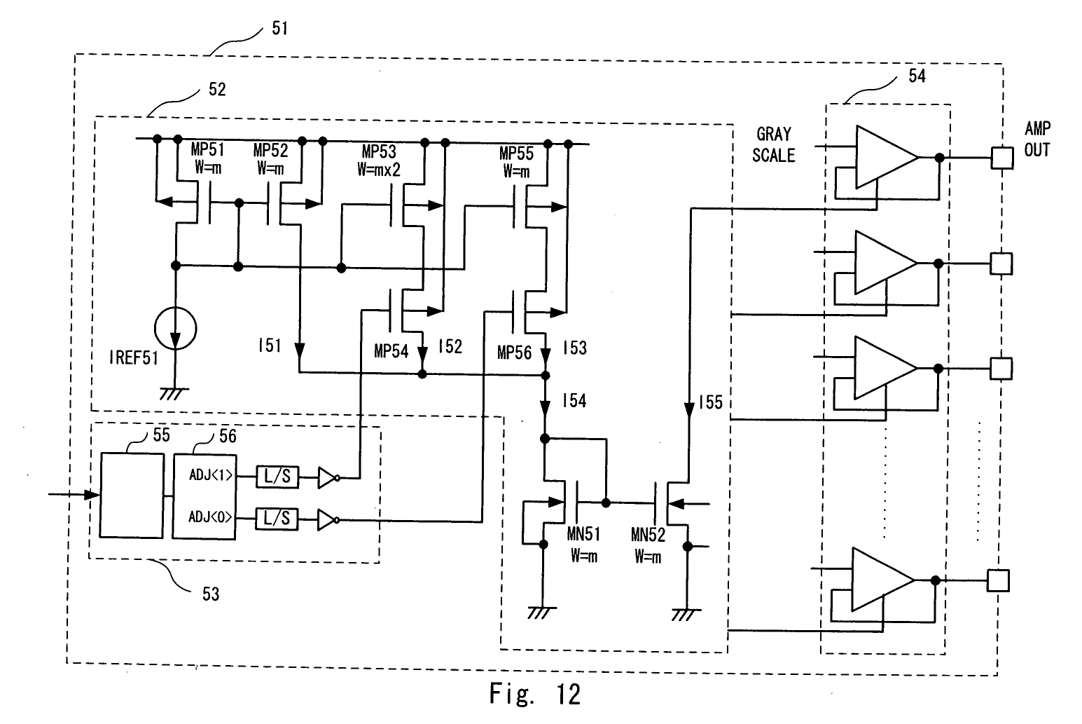

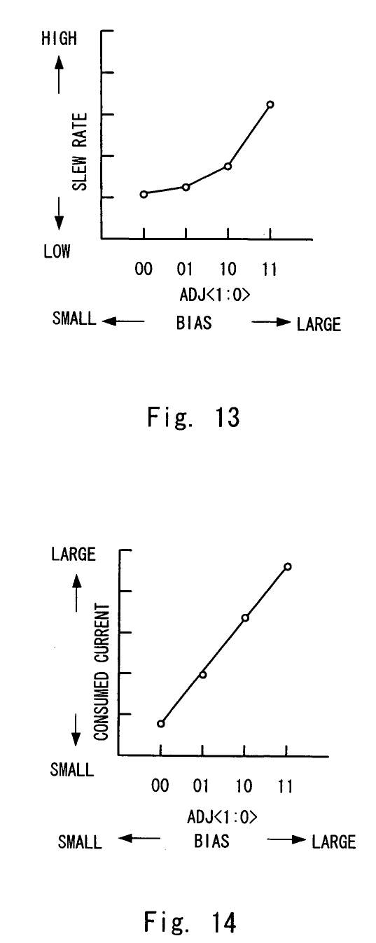

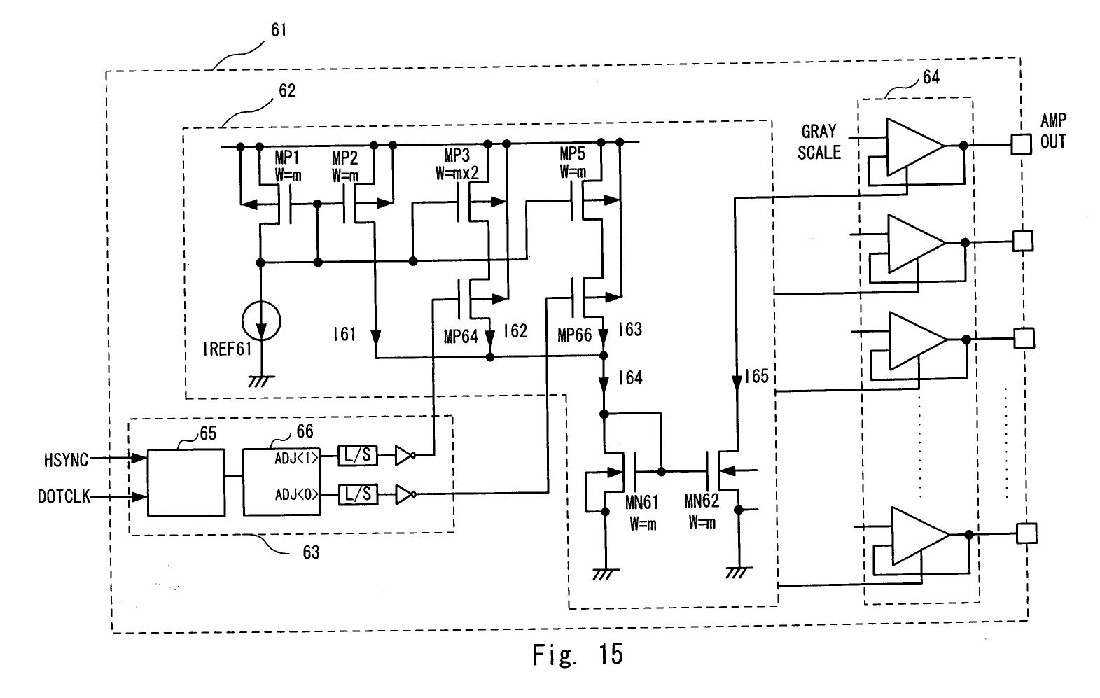

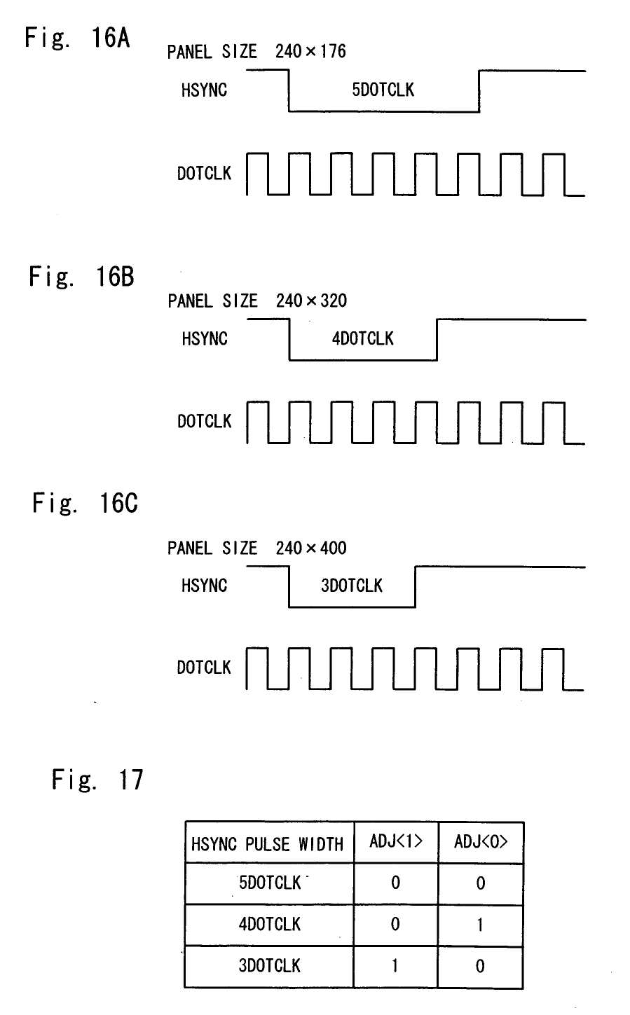

The source select signals ASEL, BSEL, and CSEL are generated in accordance with the panel select signals ASW, BSW, and CSW. FIG. 11 shows one example of the source select signal and the panel select signal. As shown in FIG. 11, ASEL is firstly raised, and BSEL is raised at the same time when ASEL is fallen between the adjacent horizontal synchronizing signals HSYNC. Thereafter, CSEL is raised at the same time when BSEL is fallen, and CSEL is fallen before the next horizontal synchronizing signal is input.

The panel select signals ASW, BSW, CSW are in Hi in a period in which each of the source select signals ASEL, BSEL, and CSEL is in Hi. The source amplifier 34 outputs the output voltage in accordance with the gray scale data in accordance with the source select signals ASEL, BSEL, and CSEL that are generated according to the panel select signals ASW, BSW, and CSW of the liquid crystal panel 40 in one horizontal period. Accordingly, each pixel is supplied with the gray scale voltage in a period in which each pixel is in conduction state by each of the panel select signals ASW, BSW, CSW.

In the third exemplary embodiment as well, the vertical line number and the horizontal pixel number of the liquid crystal panel are counted to automatically detect the panel size, so as to switch the control signal ADJ<1:0> as is similar to the second exemplary embodiment. As described above, according to the present invention, the operation bias current of the source amplifier can be controlled in accordance with the change of the size of the display panel also in the source driver of output division multiplex driving method mainly used in the liquid crystal panel of low-temperature poly-silicon (LTPS) not only in the amorphous panel. As a result, the slew rate and the consumed current can be adjusted as appropriate even when the size of the display panel that is to be driven is changed.

As described above, the source driver according to the present invention includes a counter that automatically judges the number of lines in the display panel from the vertical synchronizing signal VSYNC and the horizontal synchronizing signal HSYNC that are definitely used for display operation. Further, the source driver may include a counter that automatically judges the effective pixels in one line period by the data enable signal DE. The driver includes a circuit that generates a bias control signal of n bits that is decoded in accordance with the number of lines of the panel and the count value of the effective pixels and controls the operation bias current by the signal.

Accordingly, the change of the panel that is driven can be automatically detected by the driver itself with no special control signal from a user to control the operation bias current of the source amplifier. As a result, the slew rate and the consumed current can be adjusted to the appropriate state even when the drive panel is changed. The source driver according to the present invention is particularly suitable for display panels for portable telephones.

The first, second and third exemplary embodiments can be combined as desirable by one of ordinary skill in the art.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A source driver comprising:
a detector that detects the number of pixels of a display panel by a display signal used for display operation in the display panel;
an adjustment circuit that adjusts bias current in accordance with the number of pixels that is detected in the detector; and
an amplifier that is supplied with the bias current that is adjusted by the adjustment circuit, the amplifier outputting voltage to the display panel.

2. The source driver according to claim 1, wherein
the display signal includes a vertical synchronizing signal and a horizontal synchronizing signal, and
the detector counts the number of horizontal synchronizing signals between adjacent vertical synchronizing signals to detect a vertical pixel number of the display panel.

3. The source driver according to claim 1, wherein
the display signal includes a horizontal synchronizing signal, a dot clock, and a data enable signal, and
the detector counts the number of dot clocks while the data enable signal is in active between adjacent horizontal synchronizing signals to detect a horizontal pixel number of the display panel.

4. The source driver according to claim 1, comprising:
a control signal generator that generates a control signal of n bits in accordance with the number of pixels that is detected by the detector, wherein
the adjustment circuit adjusts the bias current by the control signal.

5. The source driver according to claim 1, wherein the source driver employs an output division multiplex driving method.

6. A drive method comprising:
detecting the number of pixels of a display panel by a display signal used for display operation in the display panel;
adjusting bias current in accordance with the number of pixels that is detected; and
supplying the bias current that is adjusted to an amplifier, and outputting voltage to the display panel.

7. The drive method according to claim 6, wherein
the display signal includes a vertical synchronizing signal and a horizontal synchronizing signal, and
the drive method comprises counting the number of horizontal synchronizing signals between adjacent vertical synchronizing signals to detect a vertical pixel number of the display panel.

8. The drive method according to claim 6, wherein
the display signal includes a horizontal synchronizing signal, a dot clock, and a data enable signal, and
the drive method comprises counting the number of dot clocks while the data enable signal is in active between adjacent horizontal synchronizing signals to detect a horizontal pixel number of the display panel.

9. The drive method according to claim 6, comprising
generating a control signal of n bits in accordance with the number of pixels that is detected; and
adjusting the bias current by the control signal.
